(19) United States
(12) Patent Application Publication
(10) Pub. No.: US 2009/0112770 A1
(43) Pub. Date: Apr. 30, 2009

(54) METHOD FOR GENERATING A CONTEXT OF MEDICAL DATA FOR MEDICAL TREATMENT

(75) Inventors: Volker Schmidt, Erfinder verstorben (DE); Hans Schull, Weisendorf (DE); David Schmidt, Erlangen (DE); Dominic Schmidt, Erlangen (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT, Munchen (DE)

(21) Appl. No.: 11/926,604

(22) Filed: Oct. 29, 2007

(51) Int. Cl. G06Q 50/00; H04K 1/00

(52) U.S. Cl. 705/51; 705/3

(57) ABSTRACT

A method for making accessible to a peer from a plurality of peers in a network items of medical data owned by an agent, the method comprising interfacing with a context of medical data, the context of medical data having at least one reference to contextual items of medical data, the contextual items of medical data comprising the items of medical data to be made accessible.

### FIELD OF THE INVENTION

The present invention relates to medical informatics, and more particularly to health information services for making available medical data to a number of medical facilities.

### BACKGROUND OF THE INVENTION

Up until recently, when a patient was handed over from one medical facility to another for continued treatment there was a lot of paperwork involved. The first medical facility, for example a hospital, clinic or a practice of a General Practitioner, issued a referral on paper, handed it to the patient and the patient had to produce this referral to the medical facility he or she has been referred to by the first medical facility. The necessary medical data, for example x-ray images, lab reports, doctor's reports and so forth, produced at the first medical facilities were even sent by post to the second medical facility or they were deposited with the patient so that he or she can submit the medical data at the second facility upon check-in. This procedure was not only very cumbersome with respect to transferring the medical data, but also precluded the patient from changing his mind about the second medical facility where he wishes to undergo further treatment. Once the referral has been issued and the medical data dispatched, it was difficult to change the medical facility one has been referred to. The patient for example might have done some research and thought it wiser to seek treatment at another medical facility, different from the second one. Many countries addressed these needs of the patients and procedures involved in choosing or changing medical facilities have been streamlined. In order to facilitate referrals in handing over patients in such a new environment, many countries have set up so called “electronical case record” schemes. Some of the more recent electronical case records are implemented by IT solutions that go under the heading of ticketing mechanisms. The ticketing scheme allows undirected communication of the patient's medical data between the two medical facilities involved in the referral procedure. Undirected communication means, that the recipient (that is the medical facility the patient is referred) is not normally known upon issuance of the referral to the patient at the current medical facility. The ticketing mechanisms work according to the “locker principle”. The patient is given a “key” (the ticket) for a central data storage facility (the “locker”), which is to hold the personal medical data of the patient. The patient than hands the key to a medical facility he or she wishes to given medical treatment. By handing over the key to the medical facility, the patient authorizes that medical facility to access and retrieve the patient's personal medical data from the central data storage facility. After it has been decided at the first medical facility, that the patient needs to undergo a continued treatment at a second medical facility, the first medical facility has an authorisation information authority issue the ticket for the patient. The patient is considered to be the owner of all the medical data that has been produced or will be produced at medical facilities. The patient hands the key to another medical facility of his or her own choosing and thus authorises the medical facility to access the medical data in the central storage facility.

The second medical facility then downloads from the central storage facility the medical data. From here the circle starts all over again if the patient is referred to a third medical facility or is going back to the first medical facility. Again, a ticket will be issued and handed to the patient to enable the patient authorising the following medical facility to access medical data produced at previous medical facilities. Data protection schemes in many countries however demand personal data not to be stored at central storage facilities. Consequently, current electronical case record schemes using the ticketing mechanism have been overhauled to address these new policies. The medical data is no longer stored centrally but the data remains decentrally with the individual medical facilities. In the EPR systems, once a medical facility has been authorised by means of the ticket to access the patient's medical data, the medical facility interfaces with some kind of central index server and connects therefrom by means of references to the corresponding medical facility the patient has been referred from. There are, however, certain diseases, for example diabetes, that normally require a series of treatments to take care of complications, the treatments being medically connected. The condition of having diabetes for example may necessitate undergoing treatment for say diabetic foot or diabetic retinopathy. Using the decentralised version of the EPR ticketing scheme explained above for series of causally connected treatments means that a medical facility is only authorised to access medical data at the previous medical facility, that is, the medical facility the patient has been referred from. The series of treatments are thought to be causally connected inasmuch as they relate to a disease including all of the complications medically connected to that disease. What is needed is a system and a method allowing a medical facility to access not only the medical data at a previous medical facility the patient has been referred from, but all the medical data distributed across all the other medical facilities that have been involved in the series of treatments in the past.

### SUMMARY OF THE INVENTION

One aspect of the present invention addresses these needs by providing a method for making accessible items of medical data to a peer from a plurality of peers in a network. The items of medical data are owned by an agent. The method comprises interfacing with a context of medical data. The context of medical data comprises at least one reference to contextual items of medical data. The contextual items of medical data comprise the items of medical data to be made accessible. The method further comprises checking an authorization of the peer to access the items of medical data. The method further comprises making accessible to the peer the items of medical data. The items of medical data are made accessible to the peer by making automatically accessible to the peer the contextual items of medical data within the context of medical data. The items of medical data are understood to mean those particular items of data the peer wishes to access. The contextual items of medical data are all the other items of data that are made automatically accessible along with the items of medical data.

By making accessible to the peer, e.g. a medical facility, the items of medical data along with the contextual items of medical data, the invention facilitates putting the items of medical data into perspective against the other contextual items of medical data. The context of medical data is a data structure that makes available all the medically relevant data to the medical facility to better assist decision on further treatment.

According to another aspect of the present invention an authorization information is checked, the authorization information being provided by the peer. The authorization information is associated with the items of medical data to be made accessible.

According to yet another aspect of the present invention the authorization information is made available to the peer by the agent who owns the items of medical data. This allows the agent to decide which one of the peers from the plurality of peers shall have access to the medical data owned by the agent.

According to another aspect of the present invention the method further comprises updating the context of medical data by adding to the context of medical data a further reference to further ones of contextual items of medical data.

According to yet another aspect of the present invention the updating of the context of medical data further comprises adding an identifier to the context of medical data. The identifier is related to the further reference to the further ones of the contextual items of medical data added to the context of medical data.

According to yet another aspect of the present invention the updating of the context of medical data further comprises adding to the context of medical data the authorization information that is provided by the peer.

Adding further ones of references to further contextual items of medical data allows the context of medical data to be updated so that when other peers from the plurality of peers wish to access the context of medical data there will be available more contextual items of medical data. The increased number of items of medical data on the other hand allows other medical facilities to gain a more accurate overview on a series of treatments the patient is undergoing.

According to another aspect of the present invention the making automatically accessible to the peer the contextual items of medical data is based on a concatenation of the references to the contextual items of medical data on the one hand with the further reference to the further ones of the contextual items of medical data added when updating the context of medical data on the other hand.

According to another aspect of the present invention this concatenation is effected by combining the authorization information which is associated with the items of medical data with the identifier relating to the further reference to the further ones of the contextual items of medical data. The concatenation can be efficiently built by bringing together information such as the identifier or the authorization information that are readily available in most of the present health information services. There is no need to generate any further information to build the concatenation. According to another aspect of the present invention, the context of medical data in effect comprises a plurality of the concatenated references to the contextual items of medical data. The plurality of concatenated references is arranged in a data structure, such as a plurality of cross-referenceable tables in a relational database management system.

According to another aspect of the present invention the authorization information is recorded on a ticket. The ticket is being issued by an authorization information authority.

According to another aspect of the present invention the context of medical data is updated by adding a reference to a further one of a context of medical data such as to obtain a nested context of medical data. Structuring the context of medical data by having a “super” context of medical data refer to a number of “sub” contexts of medical data allows defining different access policies for a number of groups of peers. Each peer is being given access to a defined number of the sub-contexts of medical data only. This feature can be used to facilitate coordination of a cooperation of a large number of medical facilities. For example, if it is felt that certain aspects of a disease should be treated by a number of specialist medical facilities then having a nested context of medical data may be more useful.

According to yet another aspect of the present invention the method comprises a further functionality of merging the context of medical data with a further one of a context of medical data such as to obtain a merged context of medical data. By building merged contexts of medical data according to the method of the present invention allows adapting the context of medical data to the individual requirements of different courses of treatments of different diseases. Medical facilities may for example decide to treat different diseases together so a merging of the respective contexts of medical data is desirable.

Another aspect of the present invention addresses the needs identified above by providing a computer readable medium having computer executable instructions for implementing any one of the above aspects of the method according to the present invention.

Another aspect of the present invention addresses the needs identified above by providing a system for implementing the method according to the present invention explained above. The present invention provides a system for making accessible to a peer from a plurality of peers in a network items of medical data owned by an agent. The system comprises a system interface for interfacing with the context of medical data; a checking module for checking an authorization of the peer to access the items of medical data; an access interface for making accessible to the peer the items of medical data by making automatically accessible to the peer the contextual items of medical data; and a data storage module for storing the context of medical data. The particular architecture of the data storage module is immaterial for the purposes of the invention: the data storage module may either be central or distributed or it may even be portable, such as a smart card. This flexibility allows the system according to the present invention to comply with a wide scope of different data protection schemes or security considerations.

According to one aspect of the present invention the checking module checks an authorization information which is provided by the peer. The authorization information is associated with the items of medical data to be made accessible.

According to an another aspect of the invention the system interface allows updating the context of medical data by adding a further reference to further ones of contextual items of medical data. The system interface further allows adding to the context of medical data an identifier relating to the further reference to the further ones of the contextual items of medical data. Yet further, the system interface allows adding to the context of medical data the authorization information provided by the peer.

According to yet another aspect of the present invention the concatenation module makes automatically accessible to the peer the contextual items of medical data by concatenation of the references to the contextual items of medical data among each other and with a further reference to the further ones of the contextual items of medical data. Alternatively, the scope of the contextual items of medical data that are made automatically accessible can be adjusted. This adjustment could for example be based on meta-date which is embedded in the context of the medical data along with the references to the contextual items of medical data. A medical facility may for example wish to access only x-ray images among the contextual items of medical data referenced by the context of medical data. In this case, a filter functionality within the system interface or the access interface could filter out non-X-ray images.

According to one aspect of the present invention the concatenation module effects the concatenation by combining the authorization information associated with the items of medical data with the identifier relating to the further reference to the further ones of the contextual items of medical data.

According to another aspect of the present invention the context of medical data comprises a plurality of concatenated references to the contextual items of medical data. The plurality of concatenated references is arranged as a data structure in the data storage module.

According to another aspect of the present invention the data storage module comprises a data management system. The data structure is implemented as a plurality of cross-referenceable tables within the database management system.

According to yet another aspect of the present invention the system could comprise an authorization information authority for issuing a ticket for the authorization information. The authorization information is recorded on the ticket.

### BRIEF DESCRIPTION OF THE DRAWINGS

The invention is described below with reference to the drawings:

FIG. 1 shows diagrammatically an example of a system according to the present invention for making available medical data for peers in a network.

FIG. 2 shows a flow chart for the method according to the present invention.

### DETAILED DESCRIPTION OF THE INVENTION

The term “peer” as used in this disclosure should be interpreted broadly to include all kind of medical facilities like hospitals, clinics, GPs practises interconnected into a network. For the purposes of this invention the network infrastructure is taken to be the world-wide-web so the method according to the present invention is web-based. Other network architectures are also possible, such as intranets. The terms medical facility and peer will be used interchangeably in the following, and preference will be given to term fitting more naturally into the explanations.

By the “agent” is meant in a first place a patient who owns items of medical data. Alternatively, the term agent may also refer to a computer-based interface associated with a patient. The “medical data” are understood to include, but is not limited to, lab reports, doctor's reports, medical images like x-rays or e-prescriptions. In general the medical data refers to all kind of data produced within the course of a treatment of a patient for a certain disease.

By the term “items of medical data” is meant the medical data the peer wishes to access. The term “contextual items of medical data” is to be construed to be broader, including all the items of medical data the peer wishes to access. The contextual items of medical data are distributed across the plurality of peers and it is understood that the particular peer is in possession of some contextual items of medical data that other peers would consider as items of medical data whenever they may wish to access them. Thus, the contextual items of medical data are distributed and stored locally at the peers.

The term “context of medical data” should be interpreted as a data structure comprising a reference to a plurality of references, each reference referring to one of the contextual items of medical data. The context of medical data should not be understood as to actually contain or hold the contextual items of medical data themselves. The references refer to the contextual items of medical data including the items of medical data the peer wants to access. The references can be realized as either Digital object identifier (DOI)-tags combined with a location identifier or as familiar uniform resource identifier UPI or as a URL, a uniform resource locator. The context of medical data may include other information such as meta-data information about the actual contextual items of medical data and other information for example expressed in XML. This meta-data or other information for example allows a navigation tool located at the peer to arrange the references to the contextual items of medical data in a manner suitable for convenient navigation by the peer. The meta-data may also serve as a basis for filter operations on the plurality of references referred to by the context of medical data as explained earlier. Correspondingly, the term “making accessible” shall be understood to mean providing those references to the contextual items of medical data, the references being referred to by the context of medical data. By making accessible those references the peer can for example acquire the contextual items of medical data by downloading.

The term “checking an authorization” as used in this disclosure should be interpreted as an action for detecting whether the agent has indeed authorized the peer to access the items of medical data. The peer, upon requesting to access items of medical data owned by the agent, produces this authorization information, the authorization information having been given to the peer earlier by the agent.

The terms “authorization information” and “ticket” should be interpreted as any kind of machine readable token or other electronic information for example a barcode or a token on a carrier, for example a smart-card. The particular way in which the authorization information is encoded on the ticket is immaterial for the purposes of the invention. The ticket, according to familiar ticketing schemes as implemented by current health systems, is normally issued by a credible authorization information authority. Upon request from a medical facility where the patient is currently treated, the authorization information authority issues a ticket to the patient so that another medical facility can be authorised to access the patient's medical data.

In the following detailed description of the embodiments, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the spirit and scope of the present inventions. The following detailed description is, therefore, not to be taken in a limiting sense, and the scope of the present inventions is defined only by the appended claims.

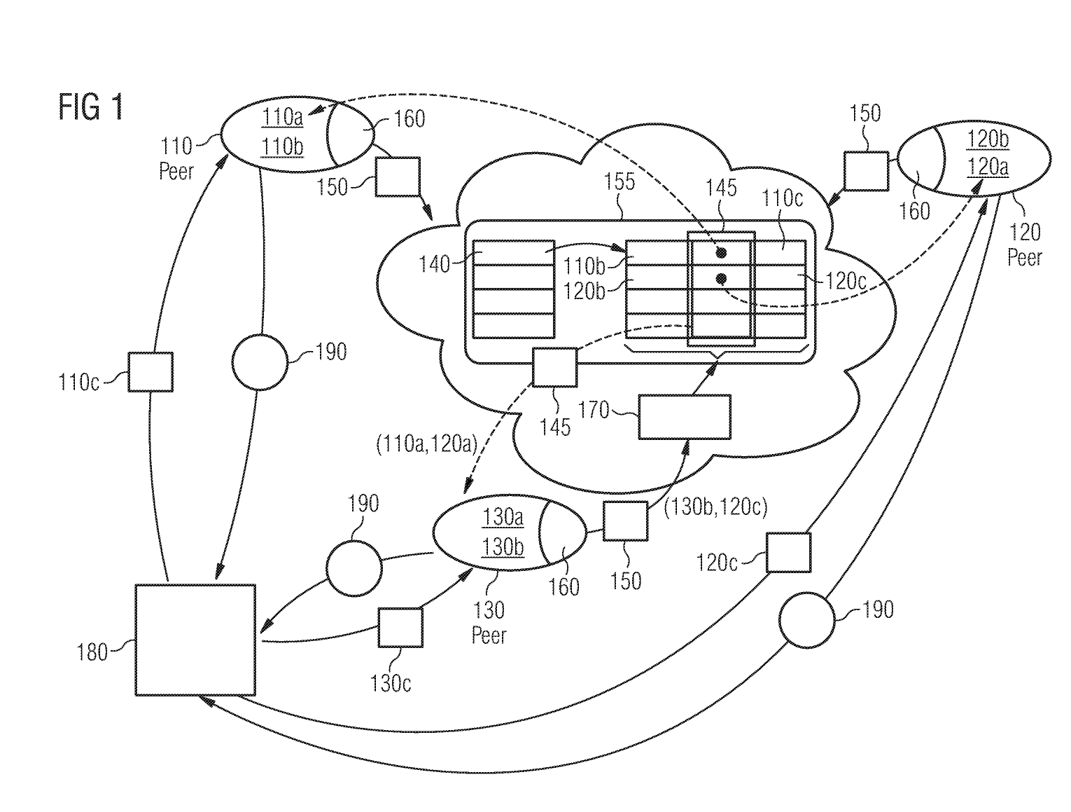

FIG. 1 shows a schematic diagram illustrating the system according to the present invention for making accessible to a peer 130 items of medical data 110a, 120a. The general situation depicted in FIG. 1 is, that a patient 190 has undergone a series of medically connected treatments first at medical facility 110 and then at medical facility 120, to which patient 190 has been referred to by medical facility 110. Medical facility 120 on the other hand has referred patient 190 to medical facility 130, where patient 190 has already checked. To keep the following explanations simple, we will refer to this situation and the system according to the present invention exemplified in FIG. 1 will be looked at form the point of view of the peer 130. This is not to be construed restrictively, as equivalent explanation can be provided from the point of view of any of other peers 110, 120.

The peer 130 is connected in a network with other peers 110 and 120. According to one aspect of the present invention the network is the World Wide Web so the system is contemplated to be web-based. Each of the peers 110, 120 and 130 are medical facilities for example clinics, hospitals or (GP practices where the patient 190 has undergone treatment in a series of treatments. During each of the treatments at the medical facilities a number of medical data 110a, 120a have been produced. The medical data 110a, 120a are not stored on a central data server. They remain with individual peers 111 and 120, albeit the patient 190 is the owner of all the medical data 110a and 120a. The system according to the present invention as depicted in FIG. 1 is making accessible to each one of the peers 110, 120, 130 all the medical data 110a, 120a distributed across all those peers by means of a data structure which is called a context of medical data 140. The context of medical data 140 can be thought of as an index of references to the other medical data 110a and 120a. The context of medical data 140 does not contain the medical data 110a and 120a themselves. The context of medical data 140 may contain data describing the medical data referenced by the context of medical data 140, such as meta-data. The meta-data can be used to navigate or to filter the context of medical data 140 in order to access a selection of the contextual items of medical data. The meta-data makes it easier for the peers to navigate the references to the medical data 110a and 120a contained within and referenced by the context of medical data 140. The context of medical data 140 is arranged as a system of cross-referenced cables of a data base management system. Other arrangements of the references to the medical data 110a and 120a are of course also possible, for example by means of linked lists or other data structures. The context of medical data 140 is shown as an entry in a table stored in the data storage module 155. Although in this example there is just one context of medical data 140 shown, it is understood that in general there could be present a number of different contexts of medical data. The context of medical data 140 refers to another table having three columns. The left column contains entries 111b and 120b designating certain identifiers of references to the different items of medical data 110a and 120a. The identifiers 111b and 120b are case numbers that are assigned at the local IT health systems at the peers 110 and 120. The case numbers have been established upon checking-in of the patient 190 at the peers 110 and 120, respectively. The center column contains the references to the items of medical data 110a and 120a, the reference themselves being schematically indicated by dots. The very right column shows entries 110c and 120c, each referring to authorisation information/codes derived from tickets, the tickets having been issued by an authorisation information authority 180. The authorisation information authority 180 is part of the familiar ticketing scheme as explained above in the background of the invention. Whenever the patient 190 is handed from one peer to another one for further treatment, the ticket is being issued by the authorisation information authority 180 on behalf of the patient 190. The ticket 120c issued by the authorisation information authority 180 allows the peer 130 to access the medical data 120a at peer 120 by means of the reference to the medical data 120a in the center column referred to by the context of medical data 140. Once the patient 190 chose peer 130 to conduct the further treatment following the treatment at peer 120 the patient presents the ticket 120c to the peer 130. The peer 130 then interfaces by means of the system interface 160 with data storage module 155 on which the context of medical data 140 is stored. Using the system interface 160 the peer transfers the authorisation information from ticket 120c. A checking module 150, sometimes also referred to as “access enforcement” modules, checks the authorisation information provided and either rejects or grants access to the context of medical data 140. An access interface 145 then makes accessible the item of medical data 120a by locating the row in the table on the right containing the entry 120c, thus matching the authorisation information from the ticket 120c. The access interface 145 hands over to the peer 130 the reference found by the access interface 145 in the same row of the table with which reference the peer 130 is able to acquire the medical data 120a from the peer 120 by, for example, downloading the medical data 120a. However, the system for making accessible medical data according to the invention described in FIG. 1 makes automatically available to peer 130 not only the medical data 120a but also the medical data 110a from peer 110.

Making available automatically both, medical data 110a and 120a, is possible because a concatenation module 170 effectively concatenates the references to the different items of medical data 120a and 110a to obtain contextual items of medical data 110a and 120a. The totality of contextual items of medical data is referenced by the context of medical data 140. By means of the concatenation executed by the concatenation module 170 a particular item of medical data is made accessible by making accessible all the contextual items of medical data, the contextual items of medical data comprising that particular item of medical data. Alternatively, the system can be adjusted to make accessible merely a subset of the contextual items of medical data within the context of medical data 140 by filtering, e.g., based on the meta-data embedded in the context of medical data 140 as explained above.

Going back to the example in FIG. 1, one can see, that after peer 130 made a request by ticket 120c for the particular item of medical data 120a the peer 130 is automatically granted access to the item of medical data 110a as well, because the references to the contextual items of medical data 110a and 120a are concatenated. The system according the invention effects the concatenation by having the peers, in this example peer 130, transfer not only the authorisation information derived from the ticket 120c but also the identifier 130b for the local case number at peer 130, the case number having being issued when the patient 190 checked-in at peer 130. Peer 130 when interfacing by means of the system interface 160 with the context of medical data 140 transfers the tuple (113b, 120c). The concatenation module 170 uses the authorisation information 120c from the tuple as a transitive link to concatenate the tuple with the second row referenced by the context of medical data 140. As can be seen in FIG. 1 the second row also contains as a rightmost entry the entry 120c. In this way the concatenation has been effected and the third table will read 130b for the case number issued at pear 130 and as a second entry in that row the references to the contextual items of medical data 130a yet to be produced at peer 130. The rightmost member of this row will be filled with the further authorisation information derived from a ticket 130c to be issued in case the patient 190 is to be handed over to yet another peer (not shown). It can be seen from the example just explained that the system updates accumulatively the context of medical data 140 by adding further rows containing a case number, a reference and authorisation information each time the patient 190 is handed over to another peer.

According to another aspect (not shown) of the invention, the context of medical data 140 does not refer directly to references to medical data but rather to other contexts, called sub-contexts of medical data. This can be realised in a standard fashion as tables in relational database systems can be cross-referenced at a large number of hierarchical levels—see for example C. J. Date, “An Introduction to Database Systems”, 8^{th} ed, Addison Wesley [2003]. By having a context of medical data refer to other contexts of medical data a nested context of medical data is obtained. The nested context of medical data is particularly useful if one wishes to implement certain access policies. A certain group of peers will be given access only to a sub-context of medical data referenced by a super-context of medical data.

According to another aspect of the present invention different contexts of medical data can be merged into one context of medical data or correspondingly a context of medical data can be unmerged and split into two separate contexts of medical data. Again, all these alternatives can be easily implemented by using standard merge/unmerge or join procedures defined for tables for relational database management systems—see again the book by C. J. Date (referenced above). Merging different contexts of medical data are particularly useful if peers decide to treat a number of diseases inflicting the patient 190 in cooperation. Unmerging the context of medical data on the other hand might be a useful option if the peers decide for example to split into dedicated task forces. Each task force is composed of a number of peers and peers from within the same task force will focus on one aspect of treatment of the disease of the patient 190. It is therefore no longer necessary for a peer within a taskforce to have access to all the contextual items of data referenced by the super-context of medical data.

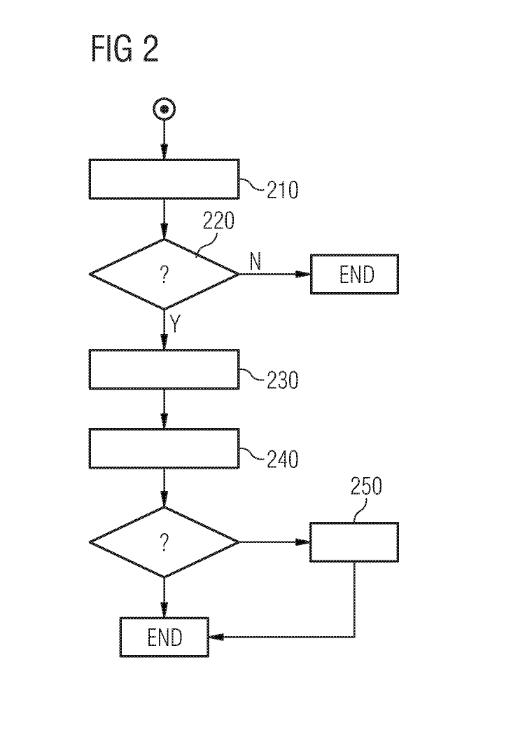

FIG. 2 is a flow chart illustrating an embodiment of a method according to the present invention, the method being implemented by the system shown on FIG. 1. The method starts out with step 210 of interfacing with a context of the medical data 140 after having established contact in step 210 interfacing, the authorisation information derived from the tickets 110c, 120c, or 130c is checked at step 220. If the authorisation information is not correct, access is rejected. Otherwise, at step 230, the items of medical data 120a are made accessible to the peer by making automatically accessible the contextual items of medical data 120a and 110a. The contextual items of medical data 110a, 120a are the totality of medical data referenced by the context of medical data 140. The contextual items of medical data 110a, 120a comprise the items of medical data 120a the peer wishes to have access to. The flow moves on to step 240 at which the context of medical data 140 is updated by adding further references to contextual items of medical data. These further ones of contextual items of medical data 130a are those ones that are to be or may be produced at the peer 130 that currently wishes to access the context of medical data 140. The reference to those further ones of contextual items of medical data might therefore not be added immediately after the peer 130 accessed the contextual items of medical data 110a, 120a. The reference to those further ones of contextual items of medical data 130a might be added at a later stage. Updating at step 230 also involves adding identifiers 130b for the case number that has been issued at the peer 130 upon check-in of the patient 190 at peer 130. As explained above and as depicted in FIG. 1, updating the context of medical data 140 by adding these case numbers 130b together with the authorisation information 120c derived from the ticket 120c is used to establish the concatenation of the references to the contextual items of medical data 110a, 120a, within the context of medical data 140. In step 240, the contextual items of medical data 110a, 120a are made accessible by making available references to the contextual items of medical data 110a, 120a. The next step is optional and stands for a number of other options introduced above, for example merging 250 a number of other contexts of medical data (not shown) with the context of medical data 140 to obtain a merged context of medical data.

It is to be understood that the above description is intended to be illustrative, and not restrictive. Many other embodiments will be apparent to those of skill in the art upon reviewing the above description. For example, as those of skill in the art will appreciate, the system and method according to the present invention can also be usefully employed in e-collaboration or e-learning schemes in which data privacy concerns need to be addressed

The scope of the invention should, therefore, be determined with reference to the appended claims, along with the full scope of equivalents to which such claims are entitled.

1.-25. (canceled)

26. A method for making accessible to a peer from a plurality of peers in a network an item of medical data owned by an agent, comprising:
interfacing with a context of the medical data comprising a reference to a contextual item of the medical data, the contextual item of the medical data comprising the item of the medical data to be made accessible;
checking an authorization of the peer to access the item of the medical data; and
making accessible to the peer the item of the medical data by automatically making accessible to the peer the contextual item of the medical data.

27. The method as claimed in claim 26, wherein the authorization of the peer to access the item of the medical data is checked by authorization information provided by the peer associated with the item of the medical data to be made accessible.

28. The method as claimed in claim 27, wherein a nested context of the medical data is obtained by adding to the context of the medical data with a further reference of a further contextual item of the medical data.

29. The method as claimed in claim 28, wherein an identifier relating to the further reference or the authorization information is added to the context of the medical data.

30. The method as claimed in claim 28, wherein the contextual item of the medical data is automatically made accessible to the peer based on a concatenation among the reference and the further reference.

31. The method as claimed in claim 30, wherein the concatenation is generated by combining the authorization information with the identifier.

32. The method as claimed in claim 30, wherein the context of the medical data comprises a plurality of concatenated references to the contextual item of the medical data that is arranged as a data structure comprising a plurality of cross-referenceable tables.

33. The method as claimed in claim 27, wherein the authorization information is recorded on a ticket issued by an authorization authority.

34. The method as claimed in claim 26, wherein a merged context of medical data is obtained by merging the context of medical data with a further context of the medical data.

35. The method as claimed in claim 26, wherein the peer comprises a medical facility and the agent comprises a patient or a computer based interface associated with the patient.

36. A computer program for executing a method of making accessible to a peer from a plurality of peers in a network an item of medical data owned by an agent, wherein the method comprising:
interfacing with a context of the medical data comprising a reference to a contextual item of the medical data, the contextual item of the medical data comprising the item of the medical data to be made accessible;
checking an authorization of the peer to access the item of the medical data; and
making accessible to the peer the item of the medical data by automatically making accessible to the peer the contextual item of the medical data.

37. A system for making accessible to a peer from a plurality of peers in a network an item of medical data owned by an agent, comprising:
a system interface that interfaces with a context of medical data comprising a reference to a contextual item of the medical data, the contextual item of the medical data comprising the item of the medical data to be made accessible;
a checking unit that checks an authorization of the peer to access the item of the medical data; and
an access interface that makes accessible to the peer the item of the medical data by automatically making accessible to the peer the contextual item of the medical data.

38. The system as claimed in claim 37, wherein the authorization of the peer to access the item of the medical data is checked by authorization information provided by the peer associated with the item of the medical data to be made accessible.

39. The system as claimed in claim 38, wherein the system interface updates the context of medical data by adding to the context of medical data with a further reference of a further contextual item of medical data.

40. The system as claimed in claim 39, wherein the context of the medical data is added to an identifier relating to the further reference or the authorization information.

41. The system as claimed in claim 39, wherein the contextual item of the medical data is automatically made accessible to the peer a based on a concatenation among the reference and the further reference.

42. The system as claimed in claim 41, wherein the concatenation is generated by combining the authorization information with the identifier.

43. The system as claimed in claim 41, wherein the context of the medical data comprises a plurality of concatenated references to the contextual item of the medical data arranged as a data structure.

44. The system as claimed in claim 43, further comprising a data storage unit that stores the context of the medical data, wherein the data storage unit comprises a database management system that implements the data structure as a plurality of cross-referenceable tables.

45. The system as claimed in claim 37, further comprising an authorization authority that issues a ticket for the authorization information being recorded on the ticket.
